(19) United States
(12) Patent Application Publication
(10) Pub. No.: US 2010/0119438 A1
(43) Pub. Date: May 13, 2010

(54) IODINE RECOVERY SYSTEM

(76) Inventors: Thomas M. Becker, Cincinnati, OH (US); Martin S. Heineke, Cincinnati, OH (US); Charles A. Schneider, Union, KY (US)

Correspondence Address: FAY SHARPE LLP, 1228 Euclid Avenue, 5th Floor, The Halle Building, Cleveland, OH, 44115, US

(21) Appl. No.: 12/617,254

(22) Filed: Nov. 12, 2009

Related U.S. Application Data
(60) Provisional application No. 61/113,787, filed on Nov. 12, 2008.

(51) Int. Cl. C01B 7/14; B01D 15/04; C25B 1/24; G01N 30/96; C01B 7/13

(52) U.S. Cl. 423/501; 210/202; 210/86; 423/504

(57) ABSTRACT

Methods for recovering iodine from an aqueous solution containing sodium chloride and iodide are disclosed. In particular, sodium hypochlorite is generated from the aqueous solution itself, and the sodium hypochlorite is used to oxidize the iodide into iodine. The iodine is then recovered from the aqueous solution.

This application claims priority from U.S. Provisional Patent Application Ser. No. 61/113,787, filed Nov. 12, 2008. The disclosure of the provisional application is hereby fully incorporated in its entirety herein.

### BACKGROUND

The present disclosure relates to a method for recovering iodine from an aqueous solution containing iodide. More particularly, the present disclosure relates to a method for recovering iodine from an aqueous solution containing iodide, comprising oxidizing iodide to iodine using sodium hypochlorite, wherein the sodium hypochlorite is generated from the aqueous solution containing iodide.

Elemental iodine or diatomic iodine (I₂) is a valuable chemical having many industrial and medicinal applications. There is an increasing demand for iodine and its major derivatives, iodide salts. The consumption of iodine and iodide salts is distributed among several industrial applications, such as catalysts, animal feed additives, stabilizers for nylon resins, inks and colorants, pharmaceuticals, disinfectants, film, and other uses. Much attention is therefore focused on the recovery of iodine from various sources, either as a primary product or as a by-product of other industrial processes.

The United States accounts for only 5% of global production, and domestic producers of iodine supply only about 28% of domestic demand, with the remainder being imported. Elemental iodine has a brown/purple color and is commercially valuable, but does not generally exist in its free state in nature. Instead, iodine exists as ions in various oxidation states, such as iodide (I¹⁻).

Iodine recovery is generally carried out by physical and/or chemical manipulation of an aqueous solution containing soluble ions of iodine like iodide (I¹⁻) or iodate (IO₃¹⁻). Exemplary solutions include leaching solutions used in nitrate extraction and brine solutions. The term “brine” in this context includes industrial and naturally occurring salt solutions containing iodine in various salt forms. Exemplary brines are seawater and natural brines such as those associated with petroleum deposits and with solution mining of salt domes.

Iodine has been isolated from gas well brine for over 80 years in various fields in Japan and Oklahoma. The brine is pumped from a number of gas wells over many miles to a centralized processing facility. In that facility, the iodide rich brine is acidified and oxidized to obtain elemental iodine (I₂). In Japan, the iodine is then adsorbed, for example using anion exchange resins or carbon, to concentrate the iodine. The adsorption media is then “stripped” of iodine by a number of techniques. In Oklahoma, the iodine is recovered from a “blow out tower” where the iodine is vaporized by heat and an air stream blowing through the oxidized brine condenses the vaporized iodine as a solid that is recovered. In either case, the leftover brine, with iodine removed, is then sent back to the field and typically injected back into the ground.

It has been known to extract iodine from aqueous solutions containing iodide, such as brine, by acidification with a mineral acid and thereafter adding an oxidant such as chlorine to liberate the iodine. This extraction is described in U.S. Pat. No. 3,346,331 to Nakamura. The reference further discloses the use of an anion-exchange resin to adsorb iodine from brine. Nakamura also discloses alternating passage over the anion-exchange resin of the iodide-containing solution, which has chlorine added to it, with the iodide-containing solution without the added chlorine. This cycle repeats until the resin is saturated. Finally the resin is treated with sodium hydroxide solution followed by a sodium chloride solution to elute iodine from the resin in the form of iodide (I¹⁻) and iodate (IO₃¹⁻). The iodine in the combined eluents is recovered by adding mineral acid to convert iodide and iodate to iodine, which will crystallize out.

U.S. Pat. No. 4,131,645 to Keblys discloses a system of iodine recovery similar to that of Nakamura. Keblys discloses passing brine through an anion-exchange resin without acidification or oxidation, whereby the resin adsorbs iodide from the brine. The adsorbed iodide is then oxidized by passing a separately prepared aqueous iodate solution through the resin. The aqueous iodate solution is acidified with hydrochloric acid to a pH of about 1-4 before use. Keblys discloses repeating cycles of passing brine then passing acidified aqueous iodate solution through the resin until the resin is saturated.

It would be desirable to develop additional methods to extract iodine from brine, and to develop additional devices or apparatuses for implementing such methods.

### BRIEF DESCRIPTION

The present disclosure provides methods for recovering iodine from an aqueous solution containing iodide, comprising oxidizing iodide to iodine using sodium hypochlorite, wherein the sodium hypochlorite is generated from the aqueous solution containing iodide. Iodine is then recovered from the aqueous solution by adsorbing the iodine onto anion-exchange resin. The aqueous solution may comprise a brine solution.

In some embodiments, the disclosure relates to methods for generating elemental iodine from an aqueous solution comprising sodium chloride and iodide, such as brine. The methods comprise (1) reacting a first portion of the aqueous solution in an electrolytic cell to produce sodium hypochlorite in the first portion; and (2) combining the first portion containing sodium hypochlorite with a second portion of the aqueous solution in a reactor to produce elemental iodine in the aqueous solution.

In some embodiments, the pH in the reactor is maintained in the range of from about 6 to about 7. In specific embodiments, the pH is maintained in the range of from 6.0 to 6.8. The pH may be maintained/adjusted by adding dilute hydrochloric acid.

The method may further include running the aqueous solution containing elemental iodine through an adsorption unit to adsorb the elemental iodine until the adsorption unit is saturated with elemental iodine. The adsorption unit can be an anion exchange column or a fixed bed of granular activated carbon.

The method may further comprise measuring the concentration of elemental iodine in the aqueous solution between the reactor and the adsorption unit, for example with a spectrophotometer. Alternatively, the concentration of iodine in the aqueous solution may be measured as it exits the adsorption unit.

The adsorption unit is usually regenerated so that it can be used again. The aqueous solution is also usually filtered. In specific embodiments, the aqueous solution is filtered prior to forming the first portion and the second portion.

The flow rate of the aqueous solution through the reactor may be adjustable. In some embodiments, the flow rate is adjusted so that the retention time in the reactor is from 15 to 20 minutes. In some embodiments, the working volume of the reactor is maintained at about half the total volume of the reactor.

The present disclosure also provides a system for recovering iodine from an aqueous solution containing iodide ions. The system comprises an inlet; a first line operatively connecting the inlet to an electrolytic cell; a second line operatively connecting the inlet to a reactor; a third line operatively connecting the electrolytic cell to the reactor; a pH unit operatively connected to the reactor; and an adsorption unit operatively connected to the reactor.

In some embodiments, the system comprises additional components. For example, the system may comprise a spectrophotometer for monitoring the production of iodine. The spectrophotometer may be located to monitor the presence of iodine between the reactor and the adsorption unit.

The pH unit may contain a dilute acid which can be pumped into the reactor to adjust the pH in the reactor. In a specific embodiment, the pH unit contains dilute hydrochloric acid.

In some embodiments, the adsorption unit is an anion exchange column. In other embodiments, the adsorption unit is a fixed bed of granular activated carbon.

Previous iodine recovery processes resulted in large quantities of strongly acidic aqueous solution (with a pH of about 4 or lower) due to the acidification of the iodine-containing brine with a mineral acid, or due to the use of acidified iodate or other acidic solution. Disposal of such material is a major issue for any iodine recovery process. This acidic brine must also be treated with a basic compound, such as sodium hydroxide, prior to release to the environment. This treatment generates sodium chloride (i.e. salt) as a waste product.

Unlike previous methods, the methods and apparatuses of the present disclosure do not require solutions with pH values less than about 4 before the brine is absorbed by the resin, during the absorption process, or while stripping iodine from the resin. Instead, the pH may range from 6.0 to 6.8. The decreased acidity produces significantly less acidified extracted brine, consequently requiring significantly less sodium hydroxide and generating less salt. These methods thus have a significantly smaller environmental impact than existing processes. Previous methods also required large amounts of chlorine, a hazardous material, for oxidizing the iodine in brine. The methods of the present disclosure reduce the need for chlorine by producing sodium hypochlorite from the brine itself. This improvement both decreases the number of materials needed to be brought to the site of iodine recovery and eliminates the need for a hazardous material.

This improvement both decreases the number of materials needed to be brought to the site of iodine recovery and eliminates the need for a hazardous material.

These and other non-limiting aspects of the present disclosure are more particularly described below.

### BRIEF DESCRIPTION OF THE DRAWINGS

The following is a brief description of the drawings, which are presented for the purpose of illustrating the exemplary embodiments disclosed herein and not for the purpose of limiting the same.

FIG. 1 is a flowchart showing a first exemplary method of the present disclosure.

FIG. 2 is a diagram showing a first exemplary system for executing the methods of the present disclosure.

FIG. 3 is a diagram showing a second exemplary system for executing the methods of the present disclosure.

FIG. 4 is a flowchart showing a second exemplary method of the present disclosure.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

The present disclosure relates to methods for recovering elemental iodine (I₂) from an aqueous solution containing salt (sodium chloride) and iodine ions, such as brine. It should be understood that the salt may be present as sodium ions and chloride ions. The methods comprise generating sodium hypochlorite from the aqueous solution itself, then using the sodium hypochlorite to oxidize the iodine ions into elemental iodine. Generally, an incoming stream of brine is separated into two portions. Sodium hypochlorite is generated in the first portion, and the first portion is subsequently combined with the second portion to produce the elemental iodine.

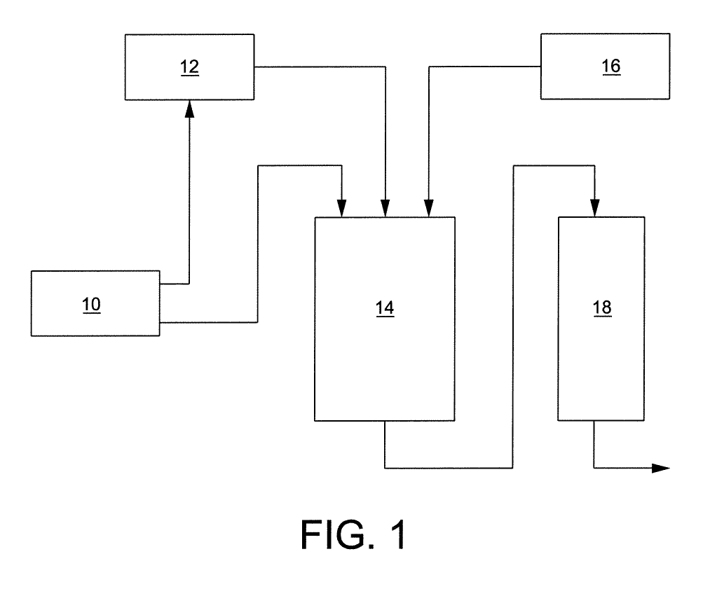

FIG. 1 is a flowchart showing iodine extraction according to an exemplary method of the present disclosure. A brine source 10 provides a first portion of an aqueous solution (i.e. brine containing iodine) to an electrolytic cell 12. A second portion of the aqueous solution is provided to a reactor 14. The transfer may occur using an aqueous solution under pressure, such as when the brine source 10 is an artesian well, or the brine may be pumped. Preferably, the brine is filtered to remove dirt particles and other filterable impurities before reaching the electrolytic cell 12 and reactor 14.

The electrolytic cell 12 receives brine from the brine source 10. Sodium chloride and water in the brine react in the electrolytic cell to produce sodium hypochlorite, commonly known as bleach and useful here as an oxidant, according to the following equations:

2NaCl+2H₂O→Cl₂+H₂+2NaOH

Cl₂+2OH¹⁻→Cl¹⁻+ClO¹⁻+H₂O

The amount of NaOCl produced is controlled by a combination of the amperage of the electrolytic cell and the flow rate of brine through the electrolytic cell 12.

Three different fluids then enter the reactor 14: brine, NaOCl, and acid 16. The first portion of brine, now containing NaOCl, flows from the electrolytic cell 12 to the reactor 14. The first portion is combined with the second portion of brine from the brine source 10 in the reactor 14. Iodide in the brine is oxidized by NaOCl to produce elemental iodine in the aqueous solution according to the following equation:

ClO¹⁻+2H¹⁺+2I¹⁻→Cl¹⁻+H₂O+I₂

The presence/production of iodine can be monitored, for example by using a spectrophotometer. Elemental iodine is colored, and absorbance may be measured at 430 nm. A user may manually adjust the amperage of the electrolytic cell, controlling the amount of NaOCl reaching the reactor, to maximize the production of iodine. Alternatively, an automated controller or computer system may adjust the amperage of the electrolytic cell based on the measured absorbance of elemental iodine to maximize the production of elemental iodine with minimal or no human intervention.

The acid maintains the pH of the aqueous solution in the reactor in a range of from about 6 to about 7. In particular embodiments, the pH is maintained in a range of from 6.0 to 6.8 by adjustment. Acid is provided to the reactor 14 by the pH unit 16, which can be a tank containing acid with a pump to transfer the acid to the reactor. In embodiments, the acid is hydrochloric acid or sulfuric acid. In particular embodiments, the acid is dilute hydrochloric acid.

In embodiments, the flow rate through the reactor 14 is adjusted to maintain about half the reactor volume as a working volume and for a retention time of from about 15 minutes to about 20 minutes. For example, a 50 gallon reactor adjusted for feed to maintain a 25 gallon working volume with a 2.5 gal/min flow rate would have a 10 minute retention time. The same reactor with a 1.25 gal/min flow rate would have a 20 minute retention time.

The aqueous solution, now containing elemental iodine, is then transferred from the reactor 14 to an iodine adsorption unit 18. A single unit or multiple units can be used. Multiple units may be connected in series, in parallel, or a combination of both. The aqueous solution containing elemental iodine is run through the adsorption unit to adsorb the elemental iodine until the adsorption unit is saturated with elemental iodine. In embodiments, the presence/concentration of iodine is measured in the aqueous solution as it travels between the reactor and the adsorption unit.

In embodiments, the iodine adsorption unit is an anion-exchange column containing a basic resin. Iodine in the aqueous solution is adsorbed by the resin. The aqueous solution containing elemental iodine is run through the resin until the resin is saturated with iodine and iodine can be detected in the eluent.

Alternatively, the iodine adsorption unit 18 may be a column containing granular activated coconut carbon particles. It has been discovered that coconut carbon particles are more efficient/effective than activated carbon produced from wood or coal. Coconut carbon particles have a superior hardness compared to other activated carbon particles. In addition, without being bound by theory, it is believed that coconut carbon particles possess more micropores than other activated carbon particles. Micropores are pores with a diameter of less than 2 nanometers. In contrast, mesopores have a diameter of from 2 to 25 nanometers and macropores have a diameter of greater than 25 nanometers. It is believed that the small size of the pores in the coconut carbon particles prevents the adsorption of larger molecules that would otherwise lower the efficiency of the activated carbon particles. This size discrimination based on the pore size also improves the yield of the overall process. The “iodine value” is referred to as a measure of the efficiency of the carbon, and coconut carbon particles have higher iodine values than other activated carbons.

Again, the aqueous solution containing iodine is run through the column until the activated coconut carbon is saturated and iodine can be detected in the eluent. For example, the granular activated carbon particles may be present as a fixed bed that is bound into a column or contained in an enclosed container or a bed. The aqueous solution is passed through the column or container that contains the fixed bed of granular activated carbon particles. The granular activated carbon particles then adsorb iodine from the solution into its pores. The detailed physical chemistry is not clearly understood, for example the exact percentage of iodide ion vs. elemental iodine, and is not relevant here. The temperature is not critical, although brine is typically a few degrees below ambient temperature because natural brine coming out of the ground is cold. In some embodiments, the pH is kept between about 5.5 and about 6.5 while the aqueous solution is contacted with the fixed bed of granular activated carbon particles (note this pH can differ from the pH in the reactor). Keeping the pH within this range inhibits higher oxidative states.

In some embodiments, the presence/concentration of iodine is measured in the aqueous solution as it exits the adsorption unit. This allows the user/computer system to confirm that iodine is properly being adsorbed and indicates when the adsorption unit is saturated with iodine. In other words, color in the solution exiting the adsorption unit indicates saturation.

The iodine adsorption unit, either the resin or the granular activated carbon particles, is relatively stable and does not require immediate recovery of the adsorbed iodine. Iodine may be recovered from the saturated iodine adsorption unit on site, or the iodine adsorption units containing saturated resin may be transported to a recovery center. Such a recovery center may recover iodine from saturated units delivered from multiple brine sources.

When the iodine adsorption unit is an anion-exchange column, elemental iodine may be recovered from the saturated resin by conventional techniques. One such technique of recovering iodine from a saturated resin is by elution with aqueous sodium hydroxide. For example, an aqueous solution containing about 10% sodium hydroxide may be passed through the column at a temperature of 55 to 65° C., preferably 60° C. Approximately 1-1.5 gallons of sodium hydroxide solution may be used for each pound of saturated resin. The resin is then regenerated to be reused. In particular embodiments, the resin is regenerated by running a solution containing 10% sodium chloride and 0.33% NaOCl, adjusted to slightly acidic with hydrochloric acid, through the resin.

Iodine may be recovered from the sodium hydroxide and sodium chloride eluents by conventional techniques. Once such technique is to combine the eluents and acidify the mixture to a pH of about 0.5 to about 3 with hydrochloric acid, preferably a pH of 0.75. The mixture is then oxidized with NaOCl to form iodine precipitate.

Iodine may be recovered from the sodium hydroxide and sodium chloride eluents by conventional techniques. Once such technique is to combine the eluents, acidify the mixture to a pH of about 2-3 with hydrochloric acid, and oxidize with bleach to form iodine precipitate.

When the iodine adsorption unit is granular activated coconut carbon, the saturated column is treated with sulfur dioxide gas (SO₂) and water (H₂O) to extract the iodine. This treatment removes the iodine from the pores of the activated carbon particles, and the resulting products are hydrogen iodide (HI) and sulfuric acid (H₂SO₄). The hydrogen iodide can then be oxidized, for example with hydrogen peroxide, to obtain elemental iodine (I₂). These reactions are illustrated below:

I₂+SO₂+2H₂O→2HI+H₂SO₄

2HI+H₂O₂→I₂+2H₂O

The removal of iodine from the adsorption unit (either the anion-exchange resin or the granular activated carbon) can be monitored as a color show: water initially entering does not have color while water exiting the adsorption unit is colored by the extracted iodine. The endpoint is thus also visible: when water passing out of the adsorption unit is clear (i.e. no more iodine is being removed), the extraction of iodine is complete. During the extraction of iodine, the temperature will rise slightly, e.g. to between 30 and 40° C., depending on reaction conditions, flow rate of recycle, time set for completion, temperature of inlet water, cooling from radiation in the equipment, etc.

Systems for implementing the methods of the present disclosure are also contemplated. Those systems include an inlet; a first line operatively connecting the inlet to an electrolytic cell; a second line operatively connecting the inlet to a reactor; a third line operatively connecting the electrolytic cell to the reactor; a pH unit operatively connected to the reactor; and an adsorption unit operatively connected to the reactor. The term “operatively” is used to indicate that the connection between two components may be direct or indirect. The meaning of this term will be further illustrated below.

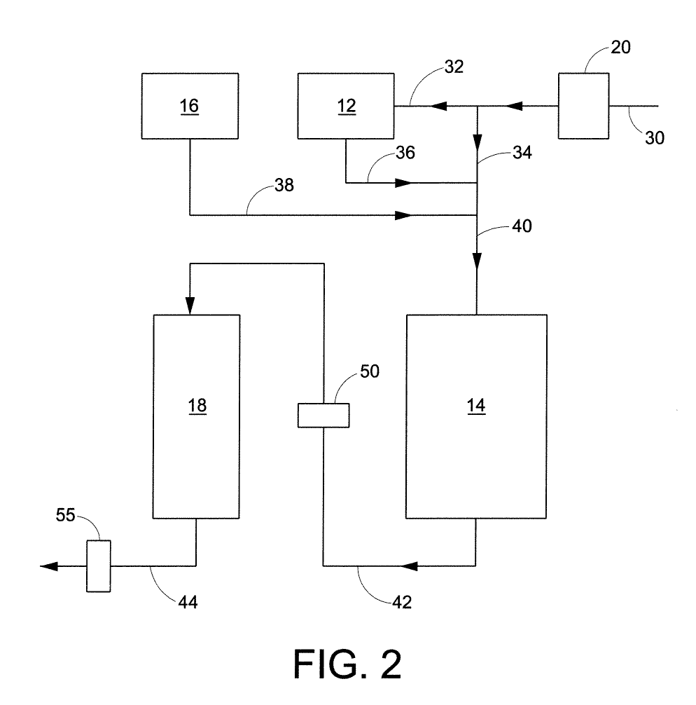

FIG. 2 is a diagram of a first exemplary system of the present disclosure. Brine enters the system through inlet 30 and passes through filter 20 to remove foreign material. After passing through the filter, the inlet 30 splits into first line 32 and second line 34. First line 32 connects directly to the electrolytic cell 12. Second line 34 connects directly to the reactor 14. A third line 36 extends from electrolytic cell 12 and connects to second line 34. The third line 36 may be considered as being indirectly connected to the reactor 14 through a portion 40 of the second line 34, i.e. operatively connected. Similarly, pH unit 16 is operatively connected to the reactor 14 through fourth line 38 and portion 40 of the second line 34. Brine then passes from reactor 14 to adsorption unit 18 through feed line 42. A monitoring unit 50 is present between the reactor 14 and the adsorption unit 18 and can be used to detect the presence/concentration of iodine in feed line 42. Similarly, monitoring unit 55 is present to detect the presence/concentration of iodine in feed line 44 exiting the adsorption unit 18.

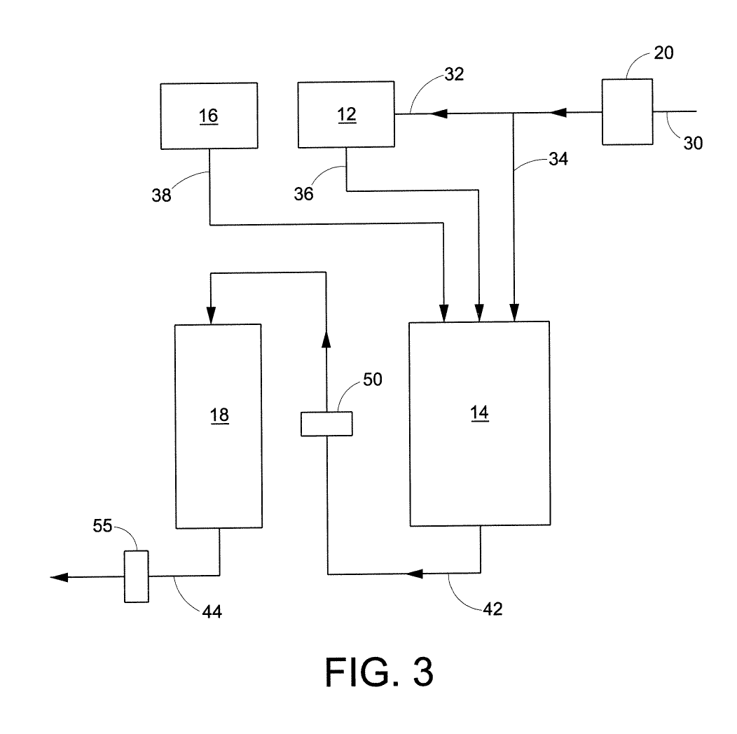

FIG. 3 is a diagram of a second exemplary system of the present disclosure. Again, brine enters the system through inlet 30 and passes through filter 20 to remove foreign material. After passing through the filter, the inlet 30 splits into first line 32 and second line 34. First line 32 connects directly to the electrolytic cell 12. Second line 34 connects directly to the reactor 14. A third line 36 then extends from electrolytic cell 12 and connects directly to second line 34. Similarly, pH unit 16 is directly connected to the reactor 14 through fourth line 38. Brine then passes from reactor 14 to adsorption unit 18 through feed line 42. A monitoring unit 50 is present between the reactor 14 and the adsorption unit 18 and can be used to detect the presence/concentration of iodine in feed line 42. Similarly, monitoring unit 55 is present to detect the presence/concentration of iodine in feed line 44 exiting the adsorption unit 18.

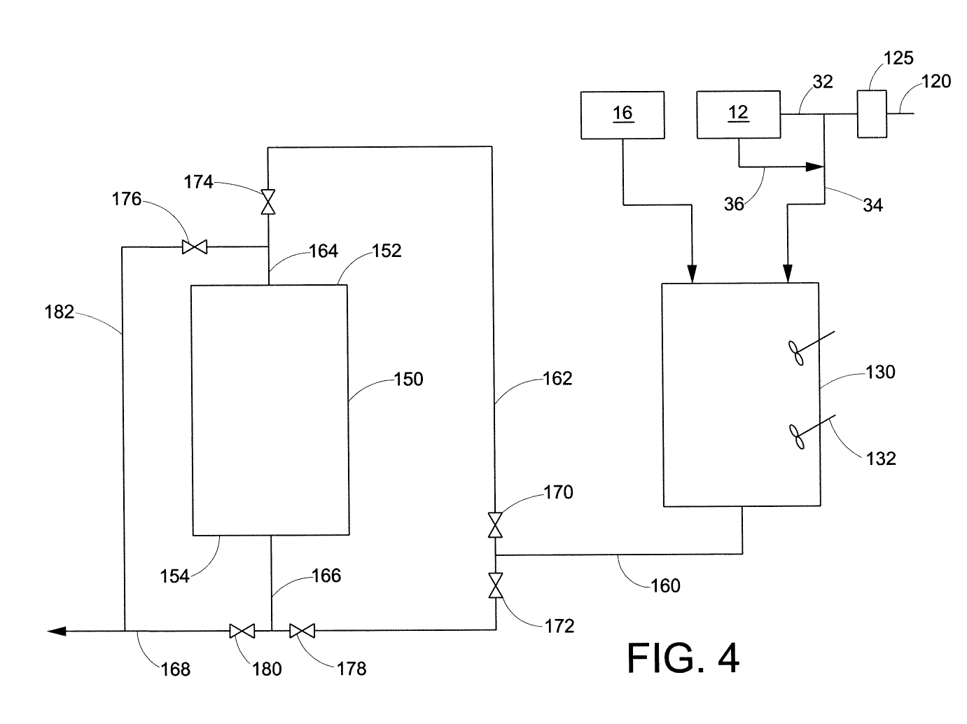

FIG. 4 is a diagram of a second exemplary method of the present disclosure. Here, acid 16 is provided from a tank or external feed. Brine enters through inlet 120 and passes through a filter 125 before being split into first line 32 and second line 34. First line 32 connects directly to the electrolytic cell 12. Second line 34 connects directly to the reactor 130. A third line 36 extends from electrolytic cell 12 and connects to second line 34. Again, third line 36 may be considered as being indirectly connected, i.e. operatively connected, to the reactor 130. The reactor 130 is a closed tank containing an agitator 132. The brine, acid, and oxidant are subsequently mixed by agitation to form elemental iodine in the brine. The brine is then sent by feed line 160 to a fixed bed 150.

Typically, foreign material is filtered out of the brine from the brine source before the brine is processed. However, it is impossible to remove 100% of the foreign material, particular very fine iron based hydroxides and hydroxide/halide complexes. As the pH of the brine is adjusted and iodine ions are oxidized to elemental iodine, these iron hydroxides and complexes (i.e. breakthrough contaminants) will also react and can precipitate into iron-based solids. These breakthrough contaminants can be trapped in the adsorption unit (particularly in granular activated carbon) and will continue to react with the fluids passing through the adsorption unit. Thus, it is generally desirable to remove these breakthrough contaminants in order to prevent contamination of the iodine as it is stripped from the fixed bed of granular activated carbon particles.

The breakthrough contaminants can be removed by means of a backwash step. Typically, the brine containing elemental iodine travels through feed lines 160, 162, and 164 to feed brine at the top 152 of the adsorption unit 150. In this arrangement, any solid breakthrough contaminants would precipitate at the top 152 of the adsorption unit 150. Iodine is adsorbed, and the waste brine, now having a reduced concentration of iodine, flows through feed lines 166 and 168 at the bottom 154 of the fixed bed to be disposed of. In this arrangement, valves 170, 174, and 180 are open, while valves 172, 176, and 178 are closed.

In the backwash step, valves 170, 174, and 180 are closed, while valves 172, 176, and 178 are opened. This causes the brine containing elemental iodine to travel through feed lines 172 and 166 to feed the brine at the bottom 154 of the adsorption unit 150. Pressure forces the brine up through the adsorption unit 150. The waste brine, now having a reduced concentration of iodine, then washes the solid breakthrough contaminants at the top 152 of the adsorption unit out of waste line 182 to remove the solid contaminants from the adsorption unit 150.

It should be noted that the backwash has no effect on the adsorption of iodine from the brine because there is an adsorption gradient in the adsorption unit 150. Because the adsorption unit is generally being fed from the top 152, the carbon particles at the top of the adsorption unit become saturated with iodine before the carbon particles at the bottom of the adsorption unit become saturated. Thus, during the backwash step, the iodine in the brine is still adsorbed by the non-saturated carbon particles at the bottom of the adsorption unit. In other words, valuable iodine is not also washed out with the solid contaminants and wasted.

The backwash step can be automated and can be scheduled as desired. For example, the backwash could occur for 10 minutes in every 12 hour period or every 24 hour period as needed.

The present disclosure has been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A method for recovering elemental iodine from an aqueous solution containing iodide, comprising oxidizing iodide to elemental iodine using sodium hypochlorite, wherein the sodium hypochlorite is generated from the aqueous solution containing iodide.

2. A method for generating elemental iodine from an aqueous solution comprising sodium chloride and iodide, the method comprising:
reacting a first portion of the aqueous solution in an electrolytic cell to produce sodium hypochlorite in the first portion; and
combining the first portion containing sodium hypochlorite with a second portion of the aqueous solution in a reactor to produce elemental iodine in the aqueous solution.

3. The method of claim 2, wherein the pH of the solution in the reactor is maintained in a range of from about 6 to about 7.

4. The method of claim 2, wherein the pH of the solution in the reactor is maintained in a range of from 6.0 to 6.8.

5. The method of claim 4, wherein the pH of the solution in the reactor is maintained by adding dilute hydrochloric acid.

6. The method of claim 2, further comprising running the aqueous solution containing elemental iodine through an adsorption unit to adsorb the elemental iodine until the adsorption unit is saturated with elemental iodine.

7. The method of claim 6, wherein the adsorption unit is an anion exchange column.

8. The method of claim 6, wherein the adsorption unit is a fixed bed of granular activated carbon.

9. The method of claim 6, further comprising measuring the concentration of elemental iodine in the solution between the reactor and the adsorption unit.

10. The method of claim 6, further comprising regenerating the adsorption unit.

11. The method of claim 6, further comprising measuring the concentration of elemental iodine in the solution exiting the adsorption unit.

12. The method of claim 2, wherein the aqueous solution is brine.

13. The method of claim 2, wherein the working volume of the reactor is maintained at about half the total volume of the reactor.

14. The method of claim 2, wherein a flow rate through the reactor is adjusted to maintain a retention time of from 15 to 20 minutes.

15. The method of claim 2, further comprising filtering the aqueous solution prior to forming the first portion and the second portion.

16. The method of claim 2, further comprising:
adsorbing the elemental iodine by passing the aqueous solution containing elemental iodine through an iodine adsorption unit; and
separating the elemental iodine from the iodine adsorption unit to obtain the elemental iodine.

17. A system for recovering elemental iodine from an aqueous solution containing iodide ions, comprising:
an inlet;
a first line operatively connecting the inlet to an electrolytic cell;
a second line operatively connecting the inlet to a reactor;
a third line operatively connecting the electrolytic cell to the reactor;
a pH unit operatively connected to the reactor; and
an adsorption unit operatively connected to the reactor.

18. The system of claim 17, further comprising a spectrophotometer located to monitor the presence of iodine between the reactor and the adsorption unit.

19. The system of claim 17, wherein the adsorption unit is an anion exchange column.

20. The system of claim 17, wherein the adsorption unit is a fixed bed of granular activated carbon.
